(19) United States
(12) Patent Application Publication
(10) Pub. No.: US 2004/0013254 A1
(43) Pub. Date: Jan. 22, 2004

(54) Setting up a conference call between members of a chat group

(76) Inventors: Max Hamberg, Vantaa (FI); Heikki Einola, Espoo (FI); Liisa Kuoppamaki, Espoo (FI); Jonne Soininen, Mountain View (FI)

Correspondence Address: Crawford Maunu, 1270 Northland Drive, Suite 390, Mendota Heights, MN, 55120, US

(21) Appl. No.: 10/363,971

(22) PCT Filed: Sep. 7, 2001
(86) PCT No.: PCT/FI01/00781

(30) Foreign Application Priority Data
Sep. 8, 2000 (FI) 20001993

(51) Int. Cl. H04M 11/00; H04M 3/42

(52) U.S. Cl. 379/202.01; 379/88.13

(57) ABSTRACT

The invention relates to a method of setting up conference calling in a communications system. In the method, at least one subscriber group having two or more subscribers is established in a server connected to the communications system; subscribers registered in the set up group chat with each other by messages in such a manner that the server in the communications system receives a message of a subscriber participating in the message chat and transmits it on to other subscribers belonging to the group in question. In the method, it is also possible to move from message chatting to conference calling by one of the subscribers in the subscriber group sending a pre-defined message to the server, which message acts as a signal to the server to move to conference calling; the server sets up a conference call between the subscribers registered as active in the subscriber group in response to receiving said pre-defined message.

### BACKGROUND OF THE INVENTION

The invention relates to setting up a conference call especially in digital communications systems.

In message chatting, a chat group is formed in a communications server by subscribers registered into a certain group. After the server has received a message sent by one of the members in the group, it sends it on to all other active members in the group.

Conference calling refers to a teleconference based on telephony between three or more participants, in which several subscribers are connected to the same call. Such a call is often referred to as a conference call or a group call. Conference calling can be set up either by the operator or the user itself.

### BRIEF DESCRIPTION OF THE INVENTION

It is an object of the invention to add to a message chat group the option of also setting up a conference call between the members of the group.

This object and other advantages provided by the invention are achieved by a method as claimed in claim 1, a communications system as claimed in claim 5 and a messaging server as claimed in claim 9. Preferred embodiments of the invention are disclosed in the dependent claims.

The invention is based on joining message chatting and conference calling operationally to each other in such a manner that it is possible to move from message chatting in a simple way to a conference call between the members of the group by transmitting to the messaging server a pre-defined message which functions as a conference call request. The server reacts to the conference call request by setting up a conference call between the active members of the group. When the call is ended, chat mode is reestablished. The functionality of a conventional message chat group can be significantly expanded by means of the invention. The invention makes it possible to set up arbitrary chat groups which can easily change from message chatting to conference calling and back. Chat groups can be defined by the users or the service provider, thus making them independent of communications operators. A conference call is, however, established between a pre-defined group with one message without any complex conference call definitions at the beginning of the call. The server can, however, utilise the conference call solutions existing in the communications network in the form of an intelligent network service, for instance, which the server triggers when receiving said message. The server can also itself act as a service switching point for the conference call, in which case it is completely independent of the communications network. One advantage provided by the invention is that it does not require any special terminal support, but works on all terminals capable of transmitting and/or receiving messages.

### BRIEF DESCRIPTION OF THE FIGURES

In the following, the invention will be described by means of preferred embodiments, with reference to the attached drawings in which

FIG. 1 illustrates a communications system to which the invention can be applied,

FIG. 2 illustrates a database of the invention,

FIG. 3 shows a flow chart of setting up a message chat,

FIG. 4 shows a flow chart of message chatting, and

FIG. 5 shows a flow chart of setting up a conference call.

### DETAILED DESCRIPTION OF THE INVENTION

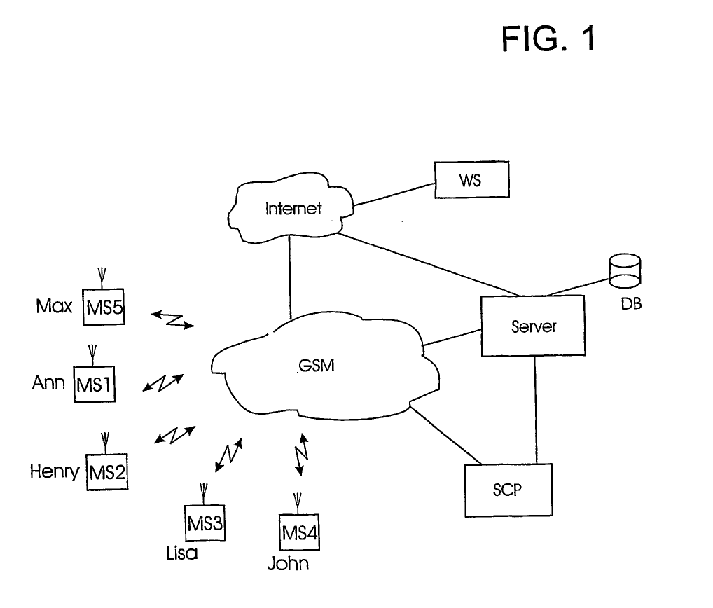

FIG. 1 shows a general system chart of a communications system to which the invention can be applied. Five subscribers ANN (MS1, Mobile Station 1), HENRY (MS2), LISA (MS3), JOHN (MS4) and MAX (MS5) are connected to the communications system, in this case a digital mobile system, i.e. a GSM (Global System for Mobile Communications) system. The mobile stations MS1 to MS5 can be conventional mobile stations equipped with a short message service. Although in the following the invention will be described by means of a short message and a short message service, a message can comprise e.g. at least one of the following messages: a short message, an instant message, an e-mail message, a multimedia message, a unified messaging message, a WAP (Wireless Application Protocol) message or a SIP (Session Initiation Protocol) message. The mobile stations can also be mobile stations equipped with e.g. an instant message, an e-mail message, a multimedia message, a unified messaging message, a WAP (Wireless Application Protocol) message or a SIP (Session Initiation Protocol) message service.

The GSM system can be directly connected to the Internet. In addition, the GSM system is connected to a quick message server SERVER of the invention. The quick message server SERVER is connected to the GSM network in the manner of an ordinary short message switching centre, but it is also possible to have speech channels connectable from the GSM network to the server SERVER for setting up a conference call as described. The quick message server can also be connected to an intelligent network, for instance to an intelligent network service control point SCP, in which case the quick message server can initiate a conference call in the GSM network as an intelligent network service. A work station (WS) represents an Internet work station, by means of which a user or a quick message service provider can through the Internet user interface of the server SERVER modify the group settings of the server or participate by means of an IP telephone (Internet Protocol, Voice over IP) in the operation of the group. A user can instead of the work station WS also use a conventional mobile station MS which has an Internet browser and the possibility to set up a data link to the Internet. A user can possibly also modify his or her user data by means of short messages instead of or as an alternative to the Internet user interface. A database DB represents a database residing in the quick message server, for instance.

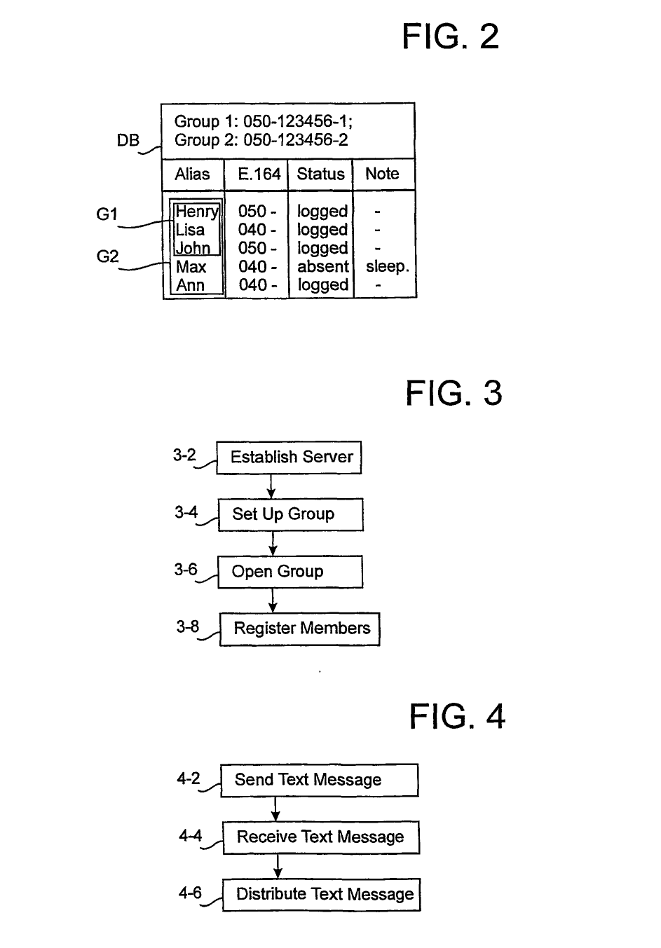

FIG. 2 shows an example of the more detailed structure of the database DB. Altogether five subscribers, their alias names being Henry, Lisa, John, Max and Ann, have registered into two short message chat groups G1 and G2. The user names, telephone numbers, status data and any possible notable matters (note) are stored for each group member in the database.

When the operator allows it, a subscriber can activate or generate a quick message group by means of a specific GENERATE message. According to an alternative mode of operation, the service provider can set up the group through his own user interface. This is usually done when one member of the group orders the service and gives the names of the other group members. For a flexible use of the service, it is, however, preferable that one or more group members are named as masters who are entitled to change group members and their rights. This can preferably be done in a fixed work station WS by means of an Internet browser by accessing the WWW (World Wide Web) site of the server SERVER. At this time, the access rights of the user are checked by requesting a user name and password, for instance. Correspondingly, the changes can be made through a mobile station with a browser and a possibility to access the Internet. The original registration of the group can have been made in the same manner through the Internet following the instructions on the Internet pages of the service provider. The user making the registration is then registered as the master when receiving the user names and passwords. An advantage of this is that less personnel is required by the service provider. Alternatively, the subscribers can be registered as groups through the Internet, for instance, according to the instructions on the Internet pages of the service provider. It is also possible that the master has at least in a restricted manner the right to modify the group data by means of short messages. In addition, all group members have the right to register as active or inactive by sending a special Login message.

In FIG. 2, Henry, Lisa, John and Ann have sent to the group's address, i.e. telephone number 050-123456-2, an activating short message LOGIN, so they are in active chat status (logged), but Max has set his status to “absent”. This status is defined so that text messages can be sent to him, but since he is not in an active status, he does not want to take part in a possible conference call set up from the short message chat. Information on Max's absence and its cause may be transmitted in a reply short message to the other group members when they send short messages to the server or initiate the conference call. Other statuses than those presented here are also possible.

The database DB of FIG. 2 shows two groups, namely the groups G1 and G2. The first group G! Includes Henry, Lisa and John. The second group G2 includes Max and Ann in addition to the members of the first group. When the members of the group G1 then communicate with each other, only the members of the group in question are allowed to participate. Likewise, when the members of the group G2 communicate with each other, only the members that belong to the group G2 are entitled to participate.

Alternatively, when establishing a conference call, the sender of the CALL message can, if necessary, define the group members with whom he wants to talk. This can be done for instance by sending a short message CALL ALIAS, wherein ALIAS represents the names of the group members. For instance, CALL LISA HENRY ANN shows that the conference call is to be established with the members LISA, HENRY and ANN.

Different groups naturally have different addresses. Thus, in FIG. 2, the address of the group G2 differs from the address of the group G1. From the above, it can also be noted that a user can simultaneously belong to more than one group and thus receive short messages, for instance, from more than one chat group. In conference calling, a user belonging to more than one group can change from one conference call to another.

FIG. 3 shows in a flow chart the action that can be taken before starting a short message chat. In step 3-2, a server SERVER is established in the short message switching centre of the mobile system, for instance. The quick message server in question can be established either temporarily or permanently. In step 3-4, a group for short message chatting is set up in the above-mentioned server by allocating memory space for it from the server. After this, the service provider can open the group in step 3-6.

Short message chat groups can be closed or open groups. Examples of closed groups include a company's board of directors, a club or a basket ball team. An example of an open group is a chat line open for everyone (0700 chatting).

After establishing the server, setting up the group and opening the group, the group members can, in step 3-8, be registered to the quick message server in question as described above, for instance. FIG. 4 shows a flow chart of a short message chat. In step 4-2, one member of the group set up in the quick message server sends to the address of the group set up in the quick message server a pre-defined short message, one containing text, for instance. In step 44, the server receives the short message and sends it in step 4-6 immediately to all subscribers registered in the group. The sender of the text message need thus not send the text message to each member of the group separately, but he or she sends the short message only once to the quick message server which distributes it to the other subscribers of the group.

Before sending a short message, the right of the member to send the short message can be checked. The routine can contain checking, for instance, if the member sending the short message has enough money to send short message(s). The quick message server can also have different check routines of checking, for instance, which group member is allowed to receive a message transmitted by a certain person. It is thus possible to have open and closed groups within open or closed groups. In addition, members of different groups can have priorities related to short message sending or receiving.

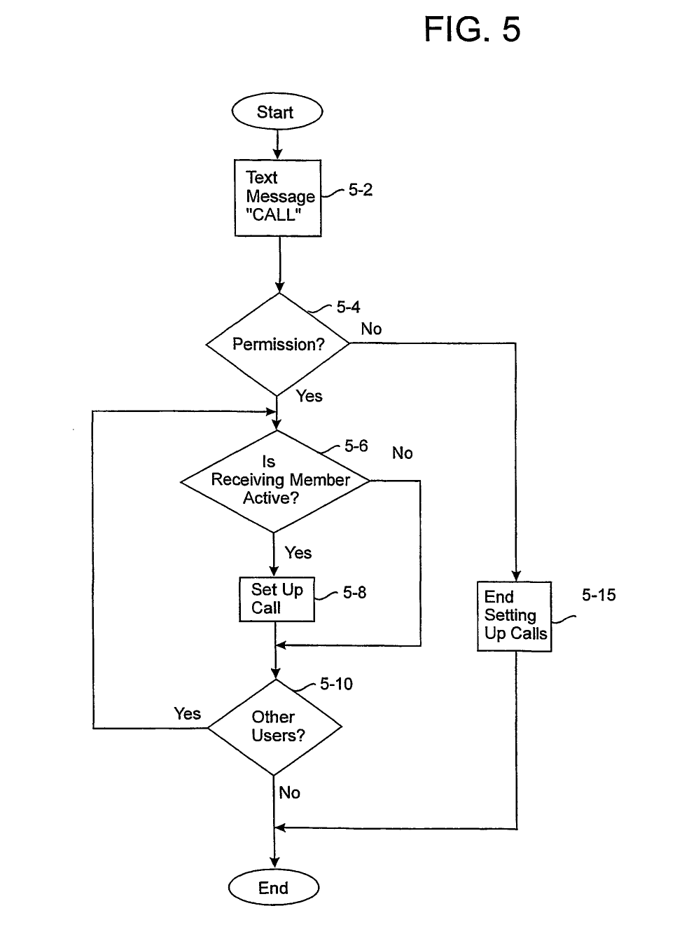

According to the invention and its preferred embodiments, a conference call can quickly and simply be set up between persons registered to a quick message group. The flow chart in FIG. 5 shows this conference call set-up. In step 5-2, a group member sends to the address of the server, for instance E.164, a short message CALL. The quick message server can then check in step 5-4 whether the subscriber sending the set-up message is registered as a member of the group in question and/or whether the member in question has the right to send this set-up message. If the member in question is registered and has the right to send the set-up message, the setting up of the conference connection is started. In step 5-6, the routine then checks if the first group member called by the server is active, in other words, does he or she want to participate in a conference call. Active status can be checked from the subscriber's status information, for instance, by sending to the subscriber in question a text message and by waiting the subscriber's reply to this or by calling the subscriber and waiting for an answer.

If the called member wants to participate in the conference call, the call is set up in step 5-8 utilising an intelligent network, for instance. The quick message server SERVER then triggers in the intelligent network service control point an intelligent network service which directs the GSM network to connect a speech connection for the called subscriber according to the instructions given by the service control point SCP, but leaves the call connection to wait for the connection of the other speech connections in the quick message server. After this, the server SERVER triggers a call set-up for all other active members of the group by performing steps 5-10, 5-6, 5-8, after which the intelligent network service directs the GSM network to connect the waiting calls into one conference call.

Instead of the intelligent network service and the GSM conference call, the quick message server SERVER can first set up the individual calls between the server and each active group member and then connect the calls to each other as a conference call in the server. This requires the possibility of setting up speech connections from the GSM network to the server and some kind of a switch in the server, but, on the other hand, the server then does not need a intelligent network interface or an intelligent network service. In such a case, the server of the invention is as independent as possible of the actual communications network.

If the subscriber sending the conference call set-up message is not registered or the member in question does not have the right to set up the conference call in question, the initiation routine of the conference call is ended in step 5-15. If the called subscriber is not active, the routine moves from step 5-6 to step 5-10, in which the routine checks if there are other users in the group that could be called. If there are other such users, the routine moves back to step 5-6.

If the number of simultaneous subscribers is limited by the number of subscribers in the conference call, this can, at the same time, limit the maximum size of a short message chat group.

The conference call is ended when all subscribers end their calls in the usual manner from their mobile stations. A single subscriber can exit the conference by ending his or her call while the other group members continue. When the conference call has been ended, the subscribers can continue exchanging short messages or at any time initiate a new conference call as described above.

Billing the method of the invention and its preferred embodiments can be implemented in may ways. These include:

the sender of the initiating CALL message pays for all calls,

the participants in the conference call pay their own share when they answer,

a fixed monthly fee is used.

The group members can thus move from short message chatting to conference calling simply by one short message. Exiting the conference call is also simple. It can, for instance, be done by each participant ending his or her own call or switching off his or her phone. Alternatively, one group member sends to the server address a message END, whereby the quick message server ends the conference call for the entire group or a part of the group. Various permission and priority checks can also be included in the ending routines of a conference call.

One advantage of the invention is that it does not require any specific terminal support, but works with the present terminals capable of sending and/or receiving short messages.

It is obvious to a person skilled in the art that while technology advances, the basic idea of the invention can be implemented in many different ways. The invention and its embodiments are thus not limited to the above examples, but may vary within the scope of the claims.

1. A method of setting up a conference call in a communications system, in which method
at least one subscriber group having two or more subscribers is set up in a server connected to the communications system; subscribers registered in the set up group chat with each other by messages in such a manner that the server in the communications system receives a message of a subscriber participating in the message chat and transmits it on to other subscribers belonging to the group in question, characterized in that
moving from message chatting to conference calling is done by one of the subscribers in the subscriber group sending to the server a pre-defined message which acts as a signal to the server to move to conference calling,
the server sets up a conference call between the subscribers registered as active in the subscriber group in response to receiving said predefined message.

2. A method as claimed in claim 1, characterized in that said messages comprise at least one of the following: short message, instant message, email message, multimedia message, unified messaging message WAP (Wireless Application Protocol) message or SIP (Session Initiation Protocol) message.

3. A method as claimed in claim 1 or 2, characterized in that
the server, in response to receiving said pre-defined message, initiates an intelligent network service which directs the communications system to connect a conference call between the subscribers advised by the server.

4. A method as claimed in claim 3, characterized in that
the server, in response to receiving said pre-defined message, sets up individual calls from the server to each active member of the subscriber group and connects the calls into a conference call in the server.

5. A communications system which comprises
subscribers,
a messaging server in which at least one subscriber group having two or more subscribers is established, the subscribers being capable of chatting together by messages in such a manner that the server in the communications system receives a message of a subscriber participating in the message chat and transmits it on to other subscribers belonging to the group in question, characterized in that
the messaging server is responsive to a pre-defined message sent by one of the subscribers in the subscriber group to the server for setting up a conference call between the subscribers registered as active in the subscriber group.

6. A communications system as claimed in claim 5, characterized in that said messages comprise at least one of the following: short message, instant message, email message, multimedia message, unified messaging message WAP (Wireless Application Protocol) message or SIP (Session Initiation Protocol) message.

7. A system as claimed in claim 5 or 6, characterized in that
the server, in response to receiving the pre-defined message, initiates an intelligent network service which directs the communications system to connect a conference call between the subscribers advised by the server.

8. A system as claimed in claim 5 or 6, characterized in that
the server, in response to receiving the pre-defined message, sets up individual calls from the server to each active member of the subscriber group and connects the calls into a conference call in the server.

9. A messaging server which is connected to a communications system and to which at least one subscriber group having two or more subscribers is established, the subscribers being capable of chaffing together by messages in such a manner that the server in the communications system receives a message of a subscriber participating in the message chat and transmits it on to other subscribers belonging to the group in question, characterized in that
the messaging server is responsive to a pre-defined message sent by one of the subscribers in the subscriber group to the server for setting up a conference call between the subscribers registered as active in the subscriber group.

10. A messaging server as claimed in claim 9, characterized in that said messages comprise at least one of the following: short message, instant message, email message, multimedia message, unified messaging message WAP (Wireless Application Protocol) message or SIP (Session Initiation Protocol) message.

11. A server as claimed in claim 9 or 10, characterized in that
the server, in response to receiving said pre-defined message, initiates an intelligent network service which directs the communications system to connect a conference call between the subscribers advised by the server.

12. A server as claimed in claim 9 or 10, characterized in that
the server, in response to receiving said pre-defined message, sets up individual calls from the server to each active member of the subscriber group and connects the calls into a conference call in the server.
